(19) United States
(12) Patent Application Publication
(10) Pub. No.: US 2012/0033850 A1
(43) Pub. Date: Feb. 9, 2012

(54) METHODS AND SYSTEMS FOR OPTICAL ASSET RECOGNITION AND LOCATION TRACKING

(76) Inventors: Kenneth G. Owens, Olivette, MO (US); James O'Neil Wickline, Federal Way, WA (US); Steve Anthony Villa, Auburn, WA (US)

(21) Appl. No.: 12/851,172

(22) Filed: Aug. 5, 2010

(51) Int. Cl. G06T 7/00

(52) U.S. Cl. 382/100; 382/190

(57) ABSTRACT

A method for managing assets associated with a platform is described. The method includes receiving an optical image of an asset associated with the platform, comparing, using an optical recognition program, the optical image of the asset to images of assets within a library of asset images to identify the asset, assigning a location for the identified asset, and updating a database, including one or more of an asset inventory and a platform configuration, based on the identification and location of the asset.

### BACKGROUND

The field of the disclosure relates generally to asset visibility, and more specifically, to methods and systems for optical asset recognition and location tracking.

In certain repair and replacement supply chains, incomplete asset visibility is still a problem. Certain entities provide products and services to aid in supply chain management including asset tracking and visibility. However, one category where asset tracking and visibility is still an issue is in regard to spares rotable tracking.

As an example, a set of aircraft components are categorized as spares rotable where the asset, or part, is removed from service and replaced with a part that is new or has already been repaired. The repaired asset may come from a supply bin of an airline or maintenance facility, from the original supplier of the aircraft, or from the original supplier of the asset. The removed asset is returned to the supplier or other facility for overhaul or repair. Once the removed asset is repaired by the supplier (or other facility) it may end up being delivered to a different customer (e.g., airline) for use. In addition, the various airline customers may store one or more of these parts (new or repaired) in supply bins such that they are available for use in service as spare parts.

Some contracts are written where the supplier owns the spares rotable assets, which are stocked at the customer's site until the asset is placed into service. Other spares rotable assets are leased so ownership belongs to the supplier throughout the lifecycle of the individual spares rotable asset. As such, certain entities are responsible for maintaining visibility and tracking of these spares rotable assets throughout the supply chain, and insuring proper logistics movement and stock levels are maintained as well as ensuring that customers have the assets needed for various operations.

Currently, when a spares rotable asset is removed for servicing, visibility is lost for several days, generally until the airline reports the removal of the asset. Sometimes asset removal notification is received via hand written reports. As a result, there are time periods when the location of the spares rotable asset may be unknown, lost, or misplaced. Suppliers of spares rotable assets are sometimes contractually obligated to maintain spare rotable assets at defined levels. If the removed spares rotable asset is not located within the contractually obligated time frame, a replacement spares rotable asset is ordered and purchased. When the originally removed spares rotable asset is finally recovered or the system catches up with the location of the spares rotable asset, the problem then becomes that an asset will be overstocked at a customer's site. Such overstocking costs suppliers money in undue expediting expenses and stocking costs.

Existing spares rotable asset solutions include manual etching of part numbers into the spares rotable asset, tagging the spares rotable assets with barcodes, tagging the spares rotable assets with radio frequency identification (RFID) tags, or tagging the asset using another automated identification technology (AIT). The etching and/or tagging is for the purpose of tracking the assets throughout the warehouse and the supply chain. In the worst of cases, certain spares rotable assets do not have any manner of parts identification. Spares rotable assets such as these are sometimes tracked based on hand written reports that are collected in batches and entered into a database, such as a customer database, for future reporting to the supplier.

One disadvantage of the existing spares rotable asset solutions is that additional costs are incurred, with each spares rotable asset needing additional processing and resources to ensure the assets are properly tagged and that the tag is functional. For certain spares rotable assets, additional complications exist with the tag adhesion. Tag adhesion is non-impacting to the part's performance and flight worthiness. Such tags are likely to be removed before the spares rotable asset is placed back into service, adding additional cost and quality processing to the part handling procedures.

The basic technologies of the existing solutions have limitations as well. Bar codes can fade over time, due to a variety of environmental factors, for example, exposure to fluids and light sources. RFID tags typically do not work well in metallic or high liquid content environments. Certain spares rotable assets have a physical shape that does not allow for a two-dimensional unit identification marking such as barcodes and RFID tags.

To track the spares rotable assets location within the supply chain, some customers hand write an asset status (removed, in bin, on dock, etc.) on paper forms. This information is provided to the supplier in batches and is therefore late in time, and thus does not provide the supplier with an accurate, real time view of where the spares rotable asset to be repaired is located or where the replacement spares rotable asset is located in the supply chain.

### BRIEF DESCRIPTION

In one aspect, a method for managing assets associated with a platform is provided. The method includes receiving an optical image of an asset associated with the platform, comparing, using an optical recognition program, the optical image of the asset to images of assets within a library of asset images to identify the asset, assigning a location for the identified asset, and updating a database, including one or more of an asset inventory and a platform configuration, based on the identification and location of the asset.

In another aspect, a system for identifying and location tracking of rotable assets associated with one or more platforms is provided. The system includes an image acquisition device operable for generating data representative of an optical image of a rotable asset, a database having data representative of three-dimensional drawings for a plurality of rotable assets, and at least one processing device programmed to associate the data representative of an optical image of a rotable asset with data representative of three-dimensional drawings for one of the plurality of rotable assets to identify the rotable asset whose image was acquired.

In still another aspect, a method for identifying a rotable asset is provided. The method include acquiring an optical image of the asset, storing the optical image in a computer memory as data representative of the acquired optical image, and comparing, using an optical recognition program, the data representative of the acquired optical image to data representative of a library of asset images to identify the asset.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a flow diagram of an aircraft production and service methodology.

FIG. 2 is a block diagram of an aircraft.

FIG. 3 is a diagram of a data processing system.

FIG. 4 is a diagram of an example computer network utilized in the image based tracking of rotable assets.

FIG. 5 is a diagram of an example computer network utilized in the tracking of assets from a first internal location to a second internal location.

FIG. 6 is a diagram of an example computer network utilized in the tracking of assets from a location to a third party location.

FIG. 7 is a flowchart illustrating an optical recognition and tracking process for assets.

### DETAILED DESCRIPTION

The embodiments described herein relate to methods and systems, including a software application, for automatically identifying a specific rotable asset, or part, for example, using a digital camera or other image acquiring device as a sensor. The data representative of the image of the specific asset as generated by the camera is then utilized to differentiate that specific asset from other assets in a known set of assets. More specifically, optical recognition software is utilized to identify an asset, and the captured image is analyzed by comparing the data representative of the captured image to a set of data representative of previously stored images. Based on the comparison, analysis and subsequent asset identification, various system configurations and other databases may be updated. Examples include a platform (e.g., aircraft) configuration database, an inventory management database, and a materials management system all of which may be updated to include data indicating one or more assets have changed location.

In the described embodiments, image data of the assets themselves are used for part identification. All other parts tracking methods, such as described above, rely on modifying the asset in some way to add a feature that will allow for the tracking of the asset. The described embodiments are different in that they utilize imaging and image recognition technology for material location tracking. More specifically, model based algorithms are utilized to identify unique features of, for example, aerospace assets which are rotated into and out of aerospace platforms. The embodiments use this asset identification capability to update three-dimensional configuration data associated with the platform (which specific part was removed and which specific part was installed in its place) as well as inventory management data for the identified asset (updated location information for the part removed from the platform and updated location information for the part installed into the platform in its place) in near real time.

Such a system, sometimes referred to herein as a materials management system, includes data relating to asset (part) identification and location for removal and replacement of such assets, where a particular instance of an asset is located in a supply system, and each platform's current asset configuration with a minimal amount of manual intervention.

The systems and methods described herein do not require adding identification features to the asset for identification. Rather, the unique physical features of an asset are utilized for identification, thereby providing a solution that can identify an asset no matter which entity the asset belongs to or which entity fabricated the asset, because the engineered features of the asset itself are used for identification. In a real world scenario, if one company tags assets with RFID, and another company tags with barcode, and yet another company does not tag assets, the materials management system and associated embodiments described herein are able to identify all of these assets without using the originally intended automated identification technology (AIT) method.

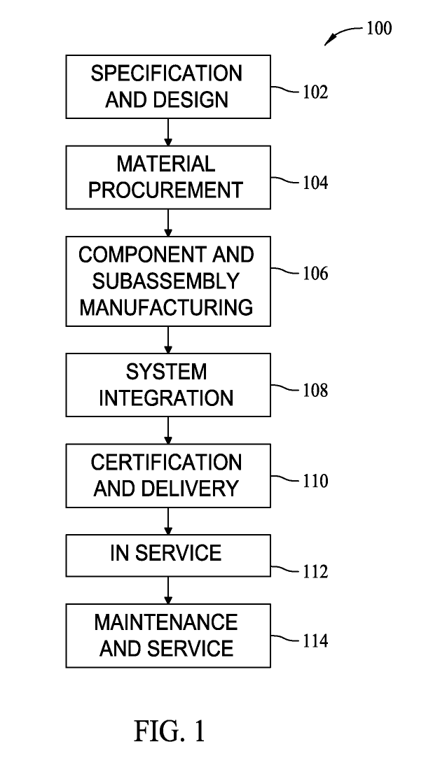

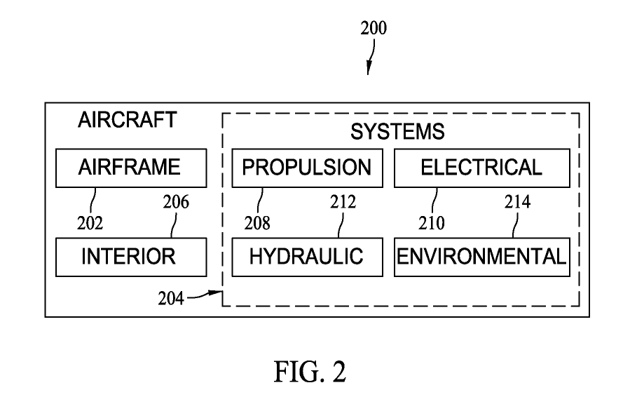

Referring more particularly to the drawings, embodiments of the disclosure may be described in the context of aircraft manufacturing and service method 100 as shown in FIG. 1 and an aircraft 200 as shown in FIG. 2. During pre-production, aircraft manufacturing and service method 100 may include specification and design 102 of aircraft 200 and material procurement 104.

During production, component and subassembly manufacturing 106 and system integration 108 of aircraft 200 takes place. Thereafter, aircraft 200 may go through certification and delivery 110 in order to be placed in service 112. While in service by a customer, aircraft 200 is scheduled for routine maintenance and service 114 (which may also include modification, reconfiguration, refurbishment, and so on).

Each of the processes of aircraft manufacturing and service method 100 may be performed or carried out by a system integrator, a third party, and/or an operator (e.g., a customer). For the purposes of this description, a system integrator may include, without limitation, any number of aircraft manufacturers and major-system subcontractors; a third party may include, for example, without limitation, any number of venders, subcontractors, and suppliers; and an operator may be an airline, leasing company, military entity, service organization, and so on.

As shown in FIG. 2, aircraft 200 produced by aircraft manufacturing and service method 100 may include airframe 202 with a plurality of systems 204 and interior 206. Examples of systems 204 include one or more of propulsion system 208, electrical system 210, hydraulic system 212, and environmental system 214. Any number of other systems may be included in this example. Although an aerospace example is shown, the principles of the disclosure may be applied to other industries, such as the automotive industry.

Apparatus and methods embodied herein may be employed during any one or more of the stages of aircraft manufacturing and service method 100. For example, without limitation, components or subassemblies corresponding to component and subassembly manufacturing 106 may be fabricated or manufactured in a manner similar to components or subassemblies produced while aircraft 200 is in service.

Also, one or more apparatus embodiments, method embodiments, or a combination thereof may be utilized during component and subassembly manufacturing 106 and system integration 108, for example, without limitation, by substantially expediting assembly of or reducing the cost of aircraft 200. Similarly, one or more of apparatus embodiments, method embodiments, or a combination thereof may be utilized while aircraft 200 is in service, for example, without limitation, to maintenance and service 114 may be used during system integration 108 and/or maintenance and service 114 to determine whether parts may be connected and/or mated to each other.

The description of the different advantageous embodiments has been presented for purposes of illustration and description, and is not intended to be exhaustive or limited to the embodiments in the form disclosed. Many modifications and variations will be apparent to those of ordinary skill in the art with each embodiment providing different advantages. The embodiment or embodiments selected are chosen and described in order to best explain the principles of the embodiments, the practical application, and to enable others of ordinary skill in the art to understand the disclosure for various embodiments with various modifications as are suited to the particular use contemplated.

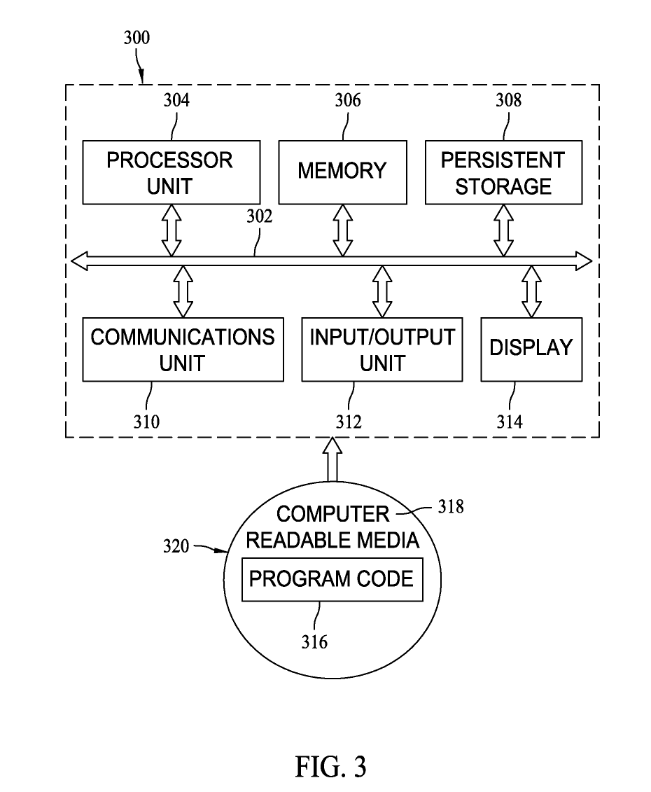

Turning now to FIG. 3, a diagram of a data processing system is depicted in accordance with an illustrative embodiment. In this illustrative example, data processing system 300 includes communications fabric 302, which provides communications between processor unit 304, memory 306, persistent storage 308, communications unit 310, input/output (I/O) unit 312, and display 314.

Processor unit 304 serves to execute instructions for software that may be loaded into memory 306. Processor unit 304 may be a set of one or more processors or may be a multi-processor core, depending on the particular implementation. Further, processor unit 304 may be implemented using one or more heterogeneous processor systems in which a main processor is present with secondary processors on a single chip. As another illustrative example, processor unit 304 may be a symmetric multi-processor system containing multiple processors of the same type.

Memory 306 and persistent storage 308 are examples of storage devices. A storage device is any piece of hardware that is capable of storing information either on a temporary basis and/or a permanent basis. Memory 306, in these examples, may be, for example, without limitation, a random access memory or any other suitable volatile or non-volatile storage device. Persistent storage 308 may take various forms depending on the particular implementation. For example, without limitation, persistent storage 308 may contain one or more components or devices. For example, persistent storage 308 may be a hard drive, a flash memory, a rewritable optical disk, a rewritable magnetic tape, or some combination of the above. The media used by persistent storage 308 also may be removable. For example, without limitation, a removable hard drive may be used for persistent storage 308.

Communications unit 310, in these examples, provides for communications with other data processing systems or devices. In these examples, communications unit 310 is a network interface card. Communications unit 310 may provide communications through the use of either or both physical and wireless communication links.

Input/output unit 312 allows for input and output of data with other devices that may be connected to data processing system 300. For example, without limitation, input/output unit 312 may provide a connection for user input through a keyboard and mouse. Further, input/output unit 312 may send output to a printer. Display 314 provides a mechanism to display information to a user.

Instructions for the operating system and applications or programs are located on persistent storage 308. These instructions may be loaded into memory 306 for execution by processor unit 304. The processes of the different embodiments may be performed by processor unit 304 using computer implemented instructions, which may be located in a memory, such as memory 306. These instructions are referred to as program code, computer usable program code, or computer readable program code that may be read and executed by a processor in processor unit 304. The program code in the different embodiments may be embodied on different physical or tangible computer readable media, such as memory 306 or persistent storage 308.

Program code 316 is located in a functional form on computer readable media 318 that is selectively removable and may be loaded onto or transferred to data processing system 300 for execution by processor unit 304. Program code 316 and computer readable media 318 form computer program product 320 in these examples. In one example, computer readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer readable media 318 also may take the form of a persistent storage, such as a hard drive, a thumb drive, or a flash memory that is connected to data processing system 300. The tangible form of computer readable media 318 is also referred to as computer recordable storage media. In some instances, computer readable media 318 may not be removable.

Alternatively, program code 316 may be transferred to data processing system 300 from computer readable media 318 through a communications link to communications unit 310 and/or through a connection to input/output unit 312. The communications link and/or the connection may be physical or wireless in the illustrative examples. The computer readable media also may take the form of non-tangible media, such as communications links or wireless transmissions containing the program code.

In some illustrative embodiments, program code 316 may be downloaded over a network to persistent storage 308 from another device or data processing system for use within data processing system 300. For instance, program code stored in a computer readable storage medium in a server data processing system may be downloaded over a network from the server to data processing system 300. The data processing system providing program code 316 may be a server computer, a client computer, or some other device capable of storing and transmitting program code 316.

The different components illustrated for data processing system 300 are not meant to provide architectural limitations to the manner in which different embodiments may be implemented. The different illustrative embodiments may be implemented in a data processing system including components in addition to or in place of those illustrated for data processing system 300. Other components shown in FIG. 3 can be varied from the illustrative examples shown.

As one example, a storage device in data processing system 300 is any hardware apparatus that may store data. Memory 306, persistent storage 308 and computer readable media 318 are examples of storage devices in a tangible form.

In another example, a bus system may be used to implement communications fabric 302 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 306 or a cache such as that found in an interface and memory controller hub that may be present in communications fabric 302.

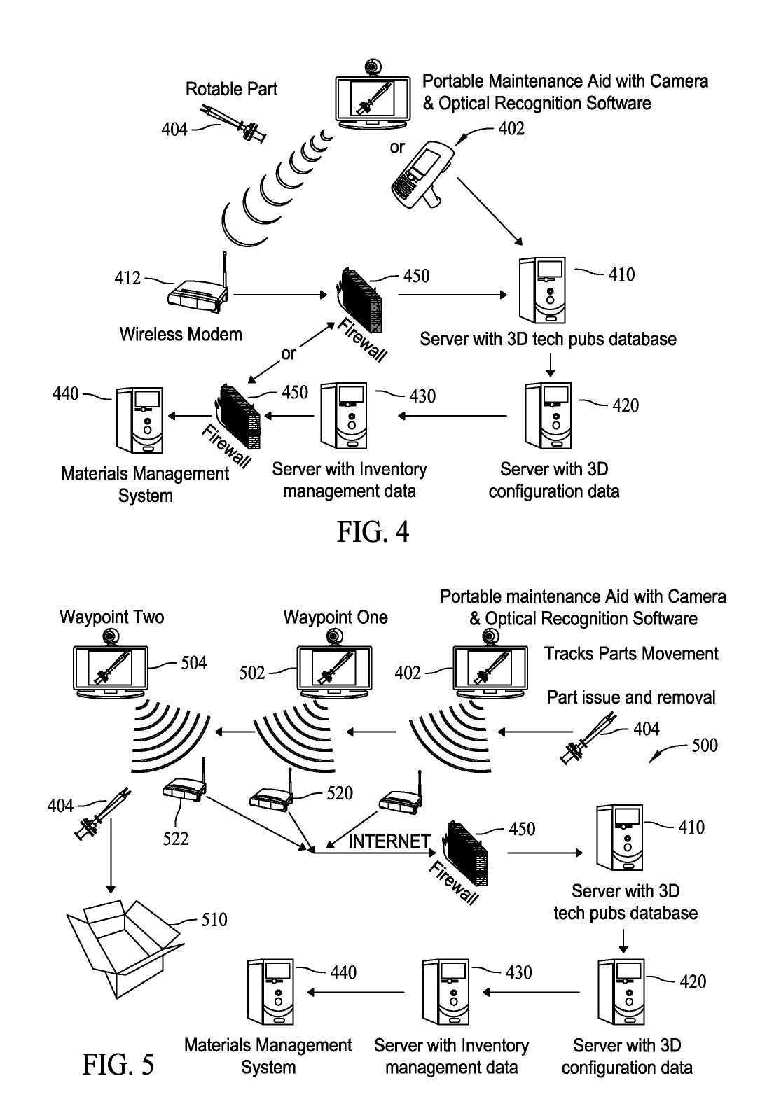

The above described data processing system 300 is one example of a processing system. Such data processing systems may be configured to operate as servers. Multiples of such data processing systems, configured as servers, may be interconnected to form networks. Using such networks, information may be shared among the individual computer systems (servers) that make up the networks. FIG. 4 is one example of such a network. More specifically, FIG. 4 is an illustration of an optical image acquisition and recognition network 400 which may be utilized in the acquisition of an optical image of an asset and in its subsequent identification.

Optical image acquisition and recognition network 400 includes an image acquisition device 402 which is operable to obtain an image of the rotable part 404, and further programmed to store data that is representative of the image. Image acquisition device 402 provides the data representing the asset image to server 410, for example, through a wired or wireless network connection. Server 410, as further explained herein, may include a three-dimensional database of technical publications useful for identifying the part whose image has been acquired. For example, server 410 is programmed to compare data representing the image of rotatable part 404 with the data within the three-dimensional database, the data representative of multiple rotable assets. Server 410 is communicatively coupled to server 420 which may include three dimensional configuration data for the platform from which the rotable part 404 was removed. Upon learning that rotable part 404 was removed from the platform, due to the matching, by server 410, of the image data with the three-dimensional database data, server 420 updates the configuration database to indicate the asset whose image has been acquired is no longer within the platform. A similar process occurs when a replacement asset for rotable part 404 is installed into the platform.

Server 430 is communicatively coupled to at least server 420. Server 430 includes inventory management data that is associated with the asset whose image has been acquired, and serves to maintain data indicative of a location of the various rotable parts that are associated with various platforms. As indicated herein, a rotable part 404 may have application across a number of platforms for a number of customers, and maintenance of the location of such rotable parts is important for efficient operations. As shown in FIG. 4, server 430 is also communicatively coupled to at least a materials management system 440 which operates as described elsewhere herein.

Image acquisition device 402 is, for example, a camera from a hand held reader or a camera interfaced to a conventional computer (portable or fixed in location). Whichever configuration, at issuance of the asset 404, image acquisition device 402 takes a picture (acquires an image) of the part and runs a parts identification algorithm that compares the data representing the image of the part to data representing a three-dimensional parts drawing stored within the technical publication database on server 410. This image comparison identifies the asset, based on comparisons with the data representative of the various parts drawings and notifies the materials management system 440 that an asset has been removed from supply. In one embodiment, part number information associated with this asset is entered into a dropdown software menu, if part number information is available, so that an operator can enter which one of many identical assets has been removed from supply. In another embodiment, asset 404 may include a permanent nameplate with alphanumeric identification thereon. Acquired images that include an image of the nameplate may be utilized with optical character recognition (OCR) programs called from the parts identification algorithm to provide identification for the part 404.

Examples of various embodiments of image acquisition device 402 are provided in the following sentences. For example, certain radio frequency identification hand-held readers have the capability of reading RFID and bar codes as well as providing imaging and wireless capabilities. As these portable readers are essentially miniature portable computers, in one embodiment, the portable reader is programmed to run the image matching application described above. In an alternative embodiment, a maintenance laptop for an airline, for example, is fitted with a small inexpensive camera and programmed to run the image matching application. In still another alternative embodiment, a desktop computer in a fixed location is combined with a camera mounted nearby and programmed to run the image matching application. Those skilled in the art are able to recognize applications where each of the embodiments may be utilized. For example, the fixed location computer can be utilized, in one embodiment, for imaging assets as the assets are moved past warehouse waypoints in order to provide accurate location data for the asset.

The location of where the asset image was acquired is important. In one embodiment, location is extrapolated from GPS referencing capabilities that are available in many devices, including hand-held and other portable processing devices. In such an embodiment, the GPS data is manually entered into the computer that acquired the image of the asset being tracked, or if the image acquisition device is capable of GPS referencing, such device is programmed to automatically enter the GPS data (e.g., the physical location of the asset) into the materials management system. If the image acquisition device is at a fixed location, the GPS data may be stored in a memory of the computer associated with the image acquisition device, and automatically associated with the data representing an acquired image of an asset. In such embodiments, location (GPS) data is transmitted along with the identification data.

With regard to portable imaging devices, one scenario is that airline maintenance personnel remove an asset that is suspected to be damaged or is scheduled for maintenance, with a replacement asset being installed onto the aircraft. The removed asset is imaged at the point of removal. The replacement asset was imaged upon removal from supply. Upon identification of the asset type, part number information is entered into the portable computing device, for example, via a dropdown menu, assuming the part number information is available for the removed asset.

If the airline is equipped with wireless technologies such that the image acquisition device 402 can communicate with server 410, for example via wireless communication, asset removal and replacement information (data representative of the asset image, identification information for the asset, and location information for the asset) will be uploaded to the server 410 in near real time. Additionally, a configuration for the aircraft is updated with the information associated with the replacement asset, at server 420 via network communications. Information relevant to asset inventory management is provided to server 430 as well. Again, such data can be uploaded to server 410 via the wireless interface, as represented by modem 412, using the remote image acquisition and identification device 402. If a wireless interface is not available, the aircraft configuration can be updated when the maintenance is complete and the portable computer/image acquisition device is docked and capable of wired communications with server 410.

Still referring to FIG. 4, and in one embodiment, once an image of an asset is acquired, the image data is compared and matched to a three dimensional image contained in a three dimensional technical publication database, for example, stored in server 410 through a network or an Internet connection using identification algorithms running on the processing devices associated with server 410. More specifically and in one embodiment, model based algorithms are utilized to identify unique features of the assets included in both the acquired image and in the technical publication database within the server 410 or other storage area. Once the part is identified, the three dimensional configuration of the platform (e.g., aircraft) is updated with the new parts information (one or more of a part number and a serial number for the asset) for storage within configuration data server 420. “In repair” data for the removed asset and the data associated with the replacement asset is then forwarded to an inventory management function (e.g., server 430) and the materials management system (e.g., server 440) updating their respective databases. While described and illustrated as separate servers, it should be understood that servers 410, 420, 430, and materials management system 440 may combined in various configuration of fewer than four machines.

Updating the materials management system 440 database allows the materials management system 440 to become aware that the customer airline is one replacement asset short in stock inventory. In one probable scenario, the materials management system 440 operates to order a stock replacement asset reducing the turn around time experienced using prior art materials management systems. As shown in FIG. 4, to provide security for, an airline customer's data, the system 400 of FIG. 4 incorporates one or more firewalls 450 strategically placed within network 400. Alternatively appropriate encryption techniques are utilized in the transfer of data from server to server.

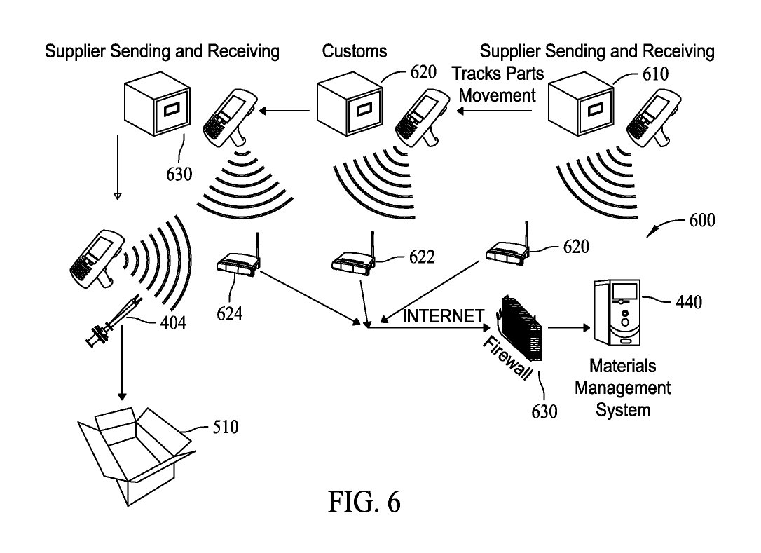

Optical asset recognition and tracking also allows the materials management system to track the removed asset (rotable part 404), which may now be referred to as an “in repair” asset, through a warehousing and logistics system. In one example, the warehousing and logistics system belongs to a customer, such as an airline, as further illustrated by the asset tracking system 500 of FIG. 5.

As described previously, a removed rotable asset 404 is imaged and identified upon removal from the platform on which it is utilized. After that process is completed, the rotable asset (which is now an “in repair” asset) may pass through a number of warehouse designated waypoints (502 and 504 in FIG. 5) until the asset 404 is finally placed into a container 510 for shipment to the supplier of the asset or a third party asset repair facility. Similarly to the asset identification process described with respect to FIG. 4, asset identification and asset location data is forwarded to the inventory management server 430 and to the materials management system 440 via a network or Internet interface as represented by modems 520 and 522.

In one embodiment, once the “in repair” asset is boxed within container 510, the acquired image of the asset is associated with a packaging label. As is known, the packaging label could contain a bar code, radio frequency identification tag or other automated identification technology (AIT). The imaging technology described with respect to the preceding figures is compatible and independent of follow-on asset tracking technology which is illustrated in FIG. 6, which is an illustration of an asset tracking system 600.

The boxed repair asset is tracked to the supplier or repair facility using existing logistics tracking methods, as the asset passes, for example, through customer sending and receiving 610 and customs 620, until it finally arrives at a final destination, for example, supplier shipping and receiving 630 where the asset 404 is finally removed from container 510. At each location along the way, the packaging label associated with asset 404 is scanned, for example, and the data regarding the asset associated with the packaging label is sent to materials management system 440. Such data is sent via a network or Internet interface as represented by modems 620, 622, and 624, the materials management system 440 likely being protected by at least one firewall 630.

When the asset 404 is removed from its container 510 at, for example, a supplier sending and receiving facility 630, the rotable asset 404 is once again imaged to confirm that the asset and associated paperwork correspond to one another. Processes similar to those described above are utilized when sending the repaired asset back to supply for eventual redeployment on a platform.

As is understood after reviewing systems 400, 500, and 600, the described embodiments are able to automatically identify and track location of an asset without additional automatic identification technologies (AIT) such as RFID or bar coding added to the asset. As described herein, the embodiments are utilized to identify an asset based solely on the inherent visual features of the asset itself.

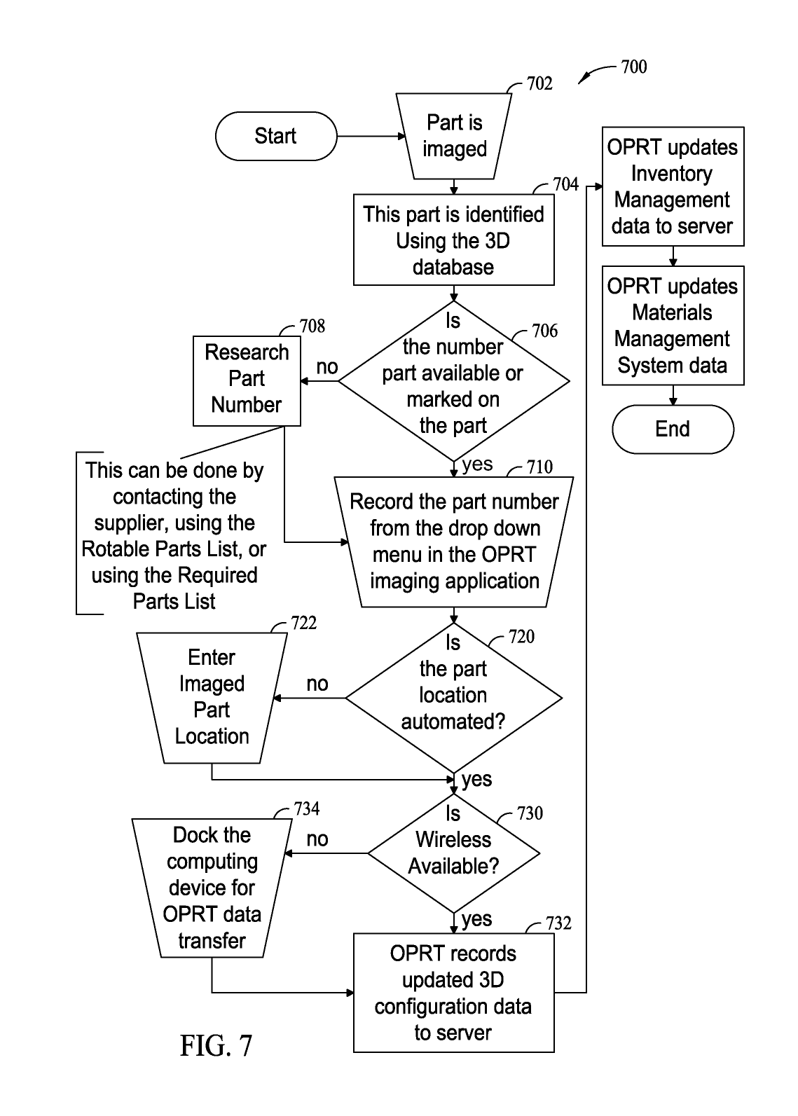

FIG. 7 is flowchart that further illustrates the process for spares rotable (e.g., asset) tracking using the above described system configurations. Though described in terms of removing an asset from an end use platform, for example a rotable asset from an aircraft, it is to be understood that the asset tracking events depicted in the flowchart 700 are mostly, if not entirely, the same at any location in the supply chain where an image of an asset may be acquired.

Referring specifically to flowchart 700, upon removal from a platform, an image of an asset is acquired 702. The asset is then identified 704 by comparing features of the acquired image with features of assets as stored in a three-dimensional asset database, as might be found, for example, in a technical publication. A determination 706 is made, of whether a specific asset part number is available or marked on the asset. If not available, the part number is researched 708, for example, by contacting a supplier of the asset, referring to a rotable parts list or referring to a required parts list.

If the specific asset part number is available or marked on the actual asset, that number is recorded 710, for example, by selecting the specific asset part number from a drop down menu or other user interface with the optical asset recognition and tracking application.

If part location data entry is automated 720, the current asset location is associated with the asset for eventual storage in one or more of a three-dimensional configuration database and an inventory management database. If part location data entry is not automated 722, the current asset location is entered manually and then associated with the asset. Based on the communications capabilities of the image acquisition device, for example, if the image acquisition device has a wireless communications capability 730, the three dimensional configuration information, including the association between location and specific asset part number are uploaded 732 to one or more servers as described above. If a wireless communications capability is not available, the uploading occurs when the acquisition device is docked 734, for example, at a docking station where the three dimensional configuration information, including the association between location and specific asset part number is then uploaded to the one or more servers as described above.

As is understood from the preceding description, the optical identification algorithms are utilized to associate a specific asset image with the correct asset part number and to create tracking scenarios based on two-dimensional or three-dimensional targets that are user defined. In order to train the optical identification algorithms on the appearance of specific assets, in one embodiment, a wireframe mesh representation of the asset is loaded, and then aligned by the user to an image of the asset provided by the camera. The software then takes the image and warps it to the wireframe to create a ‘keyframe’ which is used for future recognition of the part.

To accurately identify assets in a camera field of view, the system searches for ‘interest points’ in every frame of incoming video, searching for the correct locations and pattern corresponding to any keyframe using a search algorithm. Once a sufficient number of interest points have been found in locations corresponding to a keyframe, a match is declared.

Any company, maintenance repair organization, or airline doing service on aircraft would benefit from using the described embodiments. Though described in terms of the aerospace industry, such systems and methods are likely to find acceptance outside of the aerospace industry in any business that tracks unique specific assets for utilization within a platform. The cost of overstocking will be avoided, which includes the original cost of the extra part, expediting expenses and stocking costs.

Use of the described embodiments in the aerospace context helps to ensure visibility of spare rotable assets and reduce aircraft on ground (AOG) time, saving valuable time and money for the airline customers. Significant time and resource savings are to be realized because personnel will not be wasting time looking for lost assets. In addition, more accurate inventory accounting will save unnecessary purchasing, shipping and supply chain costs.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for managing assets associated with a platform, said method comprising:
receiving an optical image of an asset associated with the platform;
comparing, using an optical recognition program, the optical image of the asset to images of assets within a library of asset images to identify the asset;
assigning a location for the identified asset; and
updating a database, including one or more of an asset inventory and a platform configuration, based on the identification and location of the asset.

2. The method according to claim 1 wherein the asset is one of multiple assets of the same asset type, said method further comprising identifying the asset through entry of data into a user interface, the data including indicia indicative of a specific asset within the multiple assets of the same asset type.

3. The method according to claim 2 wherein the entry of indicia indicative of a specific asset includes at least one of a serial number and a part number.

4. The method according to claim 1 wherein comparing the optical image of the asset to images of assets within a library of asset images comprises using a model based algorithm to identify unique features of the asset.

5. The method according to claim 1 wherein comparing the optical image of the asset to images of assets within a library of asset images comprises comparing the received image to a three dimensional drawing within a technical publication database.

6. The method according to claim 1 wherein assigning a location for the identified asset comprises at least one of:
extrapolating a location of the identified asset from GPS referencing within the device that obtained the image of the asset;
manually entering a location into a user interface associated with a device that obtained the image of the asset; and
automatically entering a location for the identified asset into the database for an image received from an imaging device at a fixed location.

7. The method according to claim 1 wherein said receiving, said comparing, and said assigning is conducted at multiple locations associated with the asset to maintain accurate location data for the asset.

8. The method according to claim 7 wherein the multiple locations includes at least one of a warehousing waypoint, an asset repair facility, a supply bin of assets and a deployment platform for the asset.

9. The method according to claim 1 further comprising using asset location data to initiate an order for at least one replacement asset.

10. The method according to claim 1 further comprising correlating asset location data with automated information technology used in the shipping of the asset from location to location.

11. A system for identifying and location tracking of rotable assets associated with one or more platforms, said system comprising:
an image acquisition device operable for generating data representative of an optical image of a rotable asset;
a database, said database comprising data representative of three-dimensional drawings for a plurality of rotable assets; and
at least one processing device programmed to associate the data representative of an optical image of a rotable asset with data representative of three-dimensional drawings for one of the plurality of rotable assets to identify the rotable asset whose image was acquired.

12. The system according to claim 11 wherein said at least one processing device is programmed to associate a location with the data representative of an optical image of the rotable asset.

13. The system according to claim 11 wherein at least one of said image acquisition device and said at least one processing device comprise a GPS referencing capability, said at least one processing device programmed to associate a GPS location with the data representative of an optical image of the rotable asset.

14. The system according to claim 13 wherein said system is programmed to:
extrapolate a location of the identified asset from GPS referencing within said image acquisition device;
accept manually entered location data via into a user interface associated with at least one of said image acquisition device and said at least one processing device; and
automatically associate a location with the identified asset based on previously entered location data associated with an imaging device at a fixed location.

15. The system according to claim 13, said system programmed to initiate an order for at least one replacement asset based on location data associated with the data representative of an optical image of the rotable asset.

16. The system according to claim 11 wherein said image acquisition device and said at least one processing device comprise at least one of:
a portable image acquisition device;
a laptop computer comprising an image acquisition device associated therewith; and
a desktop computer in a fixed location comprising an image acquisition device associated therewith.

17. The system according to claim 11 further comprising a user interface communicatively coupled with said at least one processing device, wherein for a set of multiple assets of the same asset type, said system is operable for entry of data via said user interface, the data including indicia indicative of a specific asset within the set of multiple assets of the same asset type.

18. The system according to claim 11 wherein to associate the data representative of an optical image of a rotable asset with data representative of three-dimensional drawings for one of the plurality of rotable assets, said processing device is programmed to utilize a model based algorithm to identify unique features within the data representative of an optical image of a rotable asset and the data representative of the three-dimensional drawings for the plurality of rotable assets.

19. The system according to claim 11 wherein said data representative of three-dimensional drawings for a plurality of rotable assets comprises a technical publication database.

20. A method for identifying a rotable asset, said method comprising:
acquiring an optical image of the asset;
storing the optical image in a computer memory as data representative of the acquired optical image; and
comparing, using an optical recognition program, the data representative of the acquired optical image to data representative of a library of asset images to identify the asset.

21. The method according to claim 20 wherein said comparing provides an identification of a type of asset, said method further comprising entering data into a user interface, the data including indicia indicative of a specific asset within the identified type.

22. The method according to claim 20 wherein the data representative of the acquired optical image to data representative of a library of asset images comprises comparing the data representative of the acquired optical image to data representative of a three dimensional drawing.
